(19) United States
(12) Patent Application Publication
(10) Pub. No.: US 2010/0280838 A1
(43) Pub. Date: Nov. 4, 2010

(54) Coaching Engine for a Health Coaching Service

(76) Inventors: Adam Bosworth, San Francisco, CA (US); Anthony Skipper, South orange, NJ (US); Stephan Richter, Maynard, MA (US)

Correspondence Address: CARR & FERRELL LLP, 2200 GENG ROAD, PALO ALTO, CA, 94303, US

(21) Appl. No.: 12/434,574

(22) Filed: May 1, 2009

(51) Int. Cl. G06Q 50/00

(52) U.S. Cl. 705/2

(57) ABSTRACT

An automated coaching service executes one or more coaches for a health service user. The coaches evaluate expressions created in part from a current user status and evaluate whether any actions should be taken for the user. Once an action has been performed, the status of the user is updated and taken into account the next time user coaches are executed. Actions performed by health coach service coaches can be directed to a user or a health care professional. The health coach service can provide a dynamic coaching mechanism to the user that provides custom coaching based on the most current user health data and recent actions performed for the user.

### BACKGROUND OF THE INVENTION

1. Field of the Invention

The present invention generally relates to software engines and protocols. The present invention more specifically relates to an engine that executes protocols in the context of a health coaching service.

2. Description of the Related Art

Keeping track of personal health is an important part of living a long and productive life. To that end, various services are available to assist people in tracking different aspects of their health.

Some services provide basic health information in response to input received from a user. Existing web services, for example, provide calorie information for foods that a user might eat. Such a service allows users to list those foods that the user has consumed; the service then provides a corresponding breakdown of the calories. These services are inconvenient, however, in that they require a user to track all foods that are eaten during the course of a day when such a task is difficult enough with respect to a single meal. Most users, too, do not take the initiative to provide their meal information to the meal tracking service to access calorie information. As a result, the usefulness of such a meal tracking service is significantly reduced.

Other existing web services provide general health information to a user through a searchable database. These services present information in the context of articles, discussion forums, and other informational formats. These information web services allow users to search for, retrieve, and review content of interest. Some services may be specific to particular issues; for example, one existing web service provides information specific to diabetes.

These services, while informative at a high level, provide only the most generalized health information. That information may not be relevant or timely to the specific needs or interests of a particular user. In some instances, this generalized or high-level health information may be counterintuitive or even harmful to the needs of a user with a particular condition or issue. Further, the services require the user to proactively retrieve the general information by performing a search or other input to the service.

As an alternative to ‘one size fits all’ health services that provide generalized health information, other services have emerged that generate applications for web-based service providers who provide health information. The applications receive user input to determine a group that corresponds to and includes the user. Health information associated with the group is then provided by the application to the user.

While such a service may provide information that is more relevant to a given user, it still remains general as the health provider proffering the advice does not have access to specific user health needs or conditions. Notwithstanding the lack of a face-to-face visit, a health provider may not be able to obtain the specific health needs of or conditions from a particular user because the health provider lacks the computer skills or programming savvy to individually implement an on-line interface or community to request such information from the user.

Existing web services that provide health information directly to a particular user are often inefficient and do not have access to user data required to thoroughly address user needs. Some web services allow a user to submit a question to a practitioner with experience related to the subject matter of the question. The web service will then “post” or otherwise publish the practitioner's answer to the user's question after some period of time. Though the practitioner's answer may be directed towards a particular user, these web services do not consider any personal information about the user when addressing their question, and therefore may (again) only provide broad information that may not be individually tailored to the user. To provide theses services requires a practitioner to spend a substantial amount of time addressing the submitted questions. Further, the answer is posted by the web service and is not kept confidential between the user and the practitioner.

There is a need in the art for a health service that provides health information specific to the needs of a particular user. Such a service should offer ease of use for the end user, make efficient use of a practitioner's time and efficiently provide personalized health information for the user based on user health data.

### SUMMARY OF THE CLAIMED INVENTION

Executing a health coach can include creating a health coach by an application for the user. The user can be associated with user health data. The health coach can be stored in memory and executable by a processor and the application can be stored and executed at a computing device. The health coach can perform a first action at the computing device based on the user health data. Updated user health data can be stored in memory by the application based on the performed first action. The health coach can then be executed based on the updated user health data. A second action can be performed by the health coach at the computing device. The second action can be based on the updated user health data.

Executing a coach protocol for a user can include retrieving a list of coach service users from memory by an application. The application can be stored and executed on a computing device. The application can retrieve a list of health coaches from memory for a user in the user list. The health coaches in the health coach list can be executed by the application. An action can be performed at the computing device based on user health data by at least one of the executed coaches on the computing device

Embodiments of the method can be performed by a server in communication with a client or by the client itself. The method can also be performed by a processor executing a program contained on a computer readable storage medium.

### BRIEF DESCRIPTION OF THE DRAWINGS

FIG. 1 is an exemplary system for providing automated coaching for a user.

FIG. 2 is a flowchart of an exemplary method for providing automated coaching.

FIG. 3 is an exemplary interface for providing a meal plan.

FIG. 4 is an exemplary interface for recommending a dieting coach for a user.

FIG. 5 is an exemplary interface for recommending a health provider appointment.

FIG. 6 is an exemplary interface for providing a questionnaire.

FIG. 7 illustrates an exemplary computing system that may be used to implement an embodiment of the present invention.

### DETAILED DESCRIPTION

Embodiments of the present invention provide automated coaching to users of a health coach service. The health coach service executes one or more coaches for a health service user. The coaches evaluate expressions created in part from a current user status and evaluate whether any actions should be taken for the user. The status of a user can be based on user health data and a record of actions performed for the user. Once an action has been performed, the status of the user is updated and taken into account the next time user coaches are executed.

A coach may be implemented as software stored in memory that, when executed by a processor, evaluates a rule based on user health data and performs an action based on the evaluation. A coaching object may be instantiated with user heath data to create a coach instance with a context of a user. The coaching instance may be executed to perform an action such as provide a user with health information, analyze user data, and perform actions related to a goal or other health object data. For example, a coach instance may automatically recommend a diet based on user exercise habits, determine a likelihood that a user is at risk for heart disease, and set weight loss goals for a user.

Actions performed by health coach service coaches (e.g., coach instances) can be directed to a user or a health care professional. Actions directed to a user may include enrolling the user in a diet or workout plan, providing a questionnaire, providing a notification, or adding another coach to a list of coaches to be executed for the user. Actions directed to a health care professional can include alerting the professional to a user condition, appointment notifications or requests, or other actions.

The presently disclosed health coach service provides a dynamic coaching mechanism for a user. One or more coaches are executed for a user based on a current state of the user. As coaches are executed and actions are performed for the user, the user status changes. A user status may change by requesting a user to update user health data or performing an action and recording the action in a user action log. When the same coach is subsequently executed at some later date (e.g., the next day), the action taken for the user by the particular coach may change.

A health coach may perform an action of providing an exercise plan for the next four days to a user based on the exercise performed by the user the previous week. The next day, the health coach service may prompt the user to provide information regarding a user workout for the previous day. The health coach can then perform an action of providing an exercise plan for the remaining three days, wherein the exercise plan is updated to account for workout information recently provided. Thus, the health coach service can provide a dynamic coaching mechanism to the user that offers custom coaching based on the most current user health data and recent actions performed for the user.

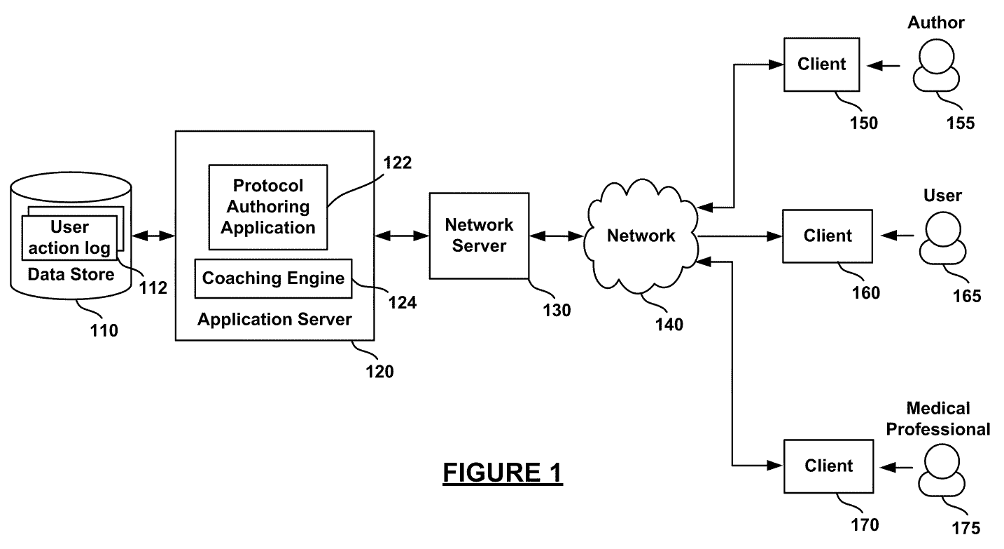

FIG. 1 is an exemplary system for providing automated coaching for a user. The system as illustrated in FIG. 1 includes data store 110, application server 120, and network server 130. Data store 110 stores user health data including attribute, range, protocol, goal, demographic, lab, medication, physical examination, past medical history, procedures, social history, vital sign, and other data. Data store 110 may also include data not associated with any particular user, such as action libraries identifying types of actions to take by a coaching engine, attribute libraries, and questionnaire libraries. Data store 110 can be implemented as a data store on the same computing device (i.e., application server 120) as coaching engine 124, as a separate storage device accessible by coaching engine 124, or a combination of the foregoing.

Application server 120 may be implemented in a general computing device that otherwise communicates with data store 110 and network server 130. Application server 120 as illustrated in FIG. 1 includes protocol authoring application 122 and coaching engine 124. Protocol authoring application 122 may be stored in memory and executed by a processor to provide interface data concerning generation of a graphical interface at a client device (e.g., client 150). This interface data may be executed and rendered as an interface by a client 150 application such as a web browser or Java® Virtual Machine. The interface generated from the interface data can be used by author 155 at client 150 for authoring a protocol related to health coaching. The protocol authoring interface as generated from execution of the authoring application 122 can include HTML, XML, scripts, or other code for rendering an authoring interface at client 150 or 160. An exemplary method for creating a coaching protocol is disclosed in U.S. patent application Ser. No. 12/360,731, filed on Jan. 27, 2009, the disclosure of which is incorporated by reference.

The client 150 may then receive input from an author 155 and transmit input data based on the input to coaching engine 124 on application server 120 or data store 110 over network 140 and network server 130. The input data can include the received input, or data identifying the input, as well as routing information for data packets intended for coaching engine 122. Coaching engine 124 is stored in memory and executable by a processor (not shown) at application server 120 to administer a user health coach protocol. Administration can include executing one or more coaches for health service users and performing actions as a result of the coach execution.

Coaching engine 124 may have access to coaching objects and a user coach list. The user coaching objects and coach list can be accessed from application server 120 or data store 110. Each of the aforementioned coaching objects may have a protocol that addresses a different aspect of providing the health service, such as providing a user with a questionnaire, advising the user to take a test or see a doctor, or recommending a diet or a workout. Coaching engine 124 may create a coach instance from a coach object stored on application server 120 or data store 110 by instantiating the coach object with user health data that includes the user status. Hence, a coaching object can be used as a template to create coaching instances.

The coach instance can be stored in memory on application server 120 or data store 110 and executed by a processor on application server 120. When executed, the coach instance can evaluate an expression to process goals, attributes, and rules to provide alerts, suggestions, updated goals, plans, status and calculated attributes, and other content for a user 165. A coach instance can also notify a health professional or other recipient regarding user health information.

Content may be provided to a user through a coaching interface at client 160. For example, user 165 at client 160 may login through a service provided by application server 120 and receive interface data as a browser application content page. The interface data may include any updates for the user health status, including updated user goals, plans, attribute values, and results of executed rule expressions.

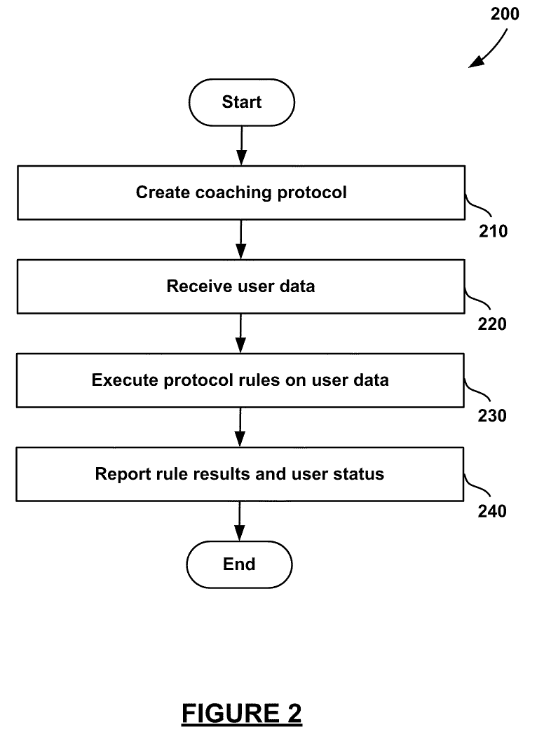

A coach instance has a context of a particular user due to the user health data used to create the instance. As such, the coach instance may be executed to evaluate the coach protocol in view of the user health data to determine if any action should be executed for the user. A number of coach instances are created, stored, and subsequently executed for each user based on the coaches listed in the user's coach list. Details of configuring and executing a coach are discussed in more detail below with respect to FIG. 2.

Coaching engine 124 may access user health data from data store 110. The user health data may be retrieved and used to populate one or more coaching interfaces provided to a user by coaching engine 124. Data received as input by a client 150 may be transmitted to coaching engine 124 and stored in data store 110.

Network 140 is inclusive of any communication network such as the Internet, Wide Area Network (WAN), Local Area Network (LAN), intranet, extranet, private network, or other network. Application server 120 may be accessed via network server 130. Network server 130 can receive and process requests from clients 150-160. Processing the requests may include sending a request to coaching engine 124 on application server 120, receiving a response from coaching engine 124, and/or forwarding that response to a requesting client 150-170.

Clients 150, 160, and 170 may be implemented as computing devices such as workstations, servers, lap top computers, mobile devices, or other computing devices that can communicate over network 140. Client 150 may include a browser application for rendering coach protocol authoring interface data as a web page interface. Client 160 may include a browser application for rendering coach interface data as web page interfaces for accessing user health updates and content. Client 170 may include a browser application for rendering coach interface data as web page interfaces for accessing notifications to a medical professional 175 regarding user health and content. Medical professional 175 can be the same or different person as author 155.

FIG. 2 is a flowchart of an exemplary method 200 for providing automated coaching. Coaching engine 124 can be implemented as software stored in memory on application server 120 and executed by a processor to perform the method of FIG. 2. As illustrated on FIG. 2, a coaching protocol is created at step 210. The protocol can be generated based on author input received through one or more interfaces derived or rendered from protocol authoring interfaces rendered at client 150. Protocol authoring application 124 transmits interface data to be rendered as an interface at client 150. An author 155 provides input to client 150 through the rendered interface and the client 150 transmits input data to coaching engine 124 via network 140 and network server 130.

Creating a coaching protocol can include setting user ranges, attributes, goals and rules authored by a protocol author 155. Ranges can be set by a protocol author for one or more user attribute values with one or more ranges for each attribute. User attributes can include simple attributes and calculated attributes. Simple attributes can be provided by a user or some other source and stored as they are received. Calculated attributes can be derived from the simple attributes, other calculated attributes, and/or other data.

A user goal can be set for any number of user attributes. The goal can specify an attribute, time, description, timeline and/or other data relating to the goal. Goal input received from a protocol author 155 can be transmitted by client 150 to protocol authoring application 122 or coaching engine 124, either of which can store the goal data locally or remotely to data store 110.

A user rule can include an expression for evaluation, an action to be taken based on the outcome of the evaluation, and timing or periodicity data indicating when the rule should be evaluated. Evaluation of a rule can result in an action to take with respect to one or more users. An author can configure a rule action as a notification, instructions to exercise, diet, take lab test, see a particular health care provider, enroll in a program, fill out a questionnaire, improve a value, or some other action. Rule periodicity information indicates how often a rule action should be performed.

After creating the coaching protocol in FIG. 2, user data can be received at step 220. The received data can include user demographic information, attributes, past medical history, family history, vaccinations, social history, procedures, allergies, lab data, and other data. The user data can be received through user questionnaires provided by the health coach service, data provided from medical facilities, lab test results, or other sources.

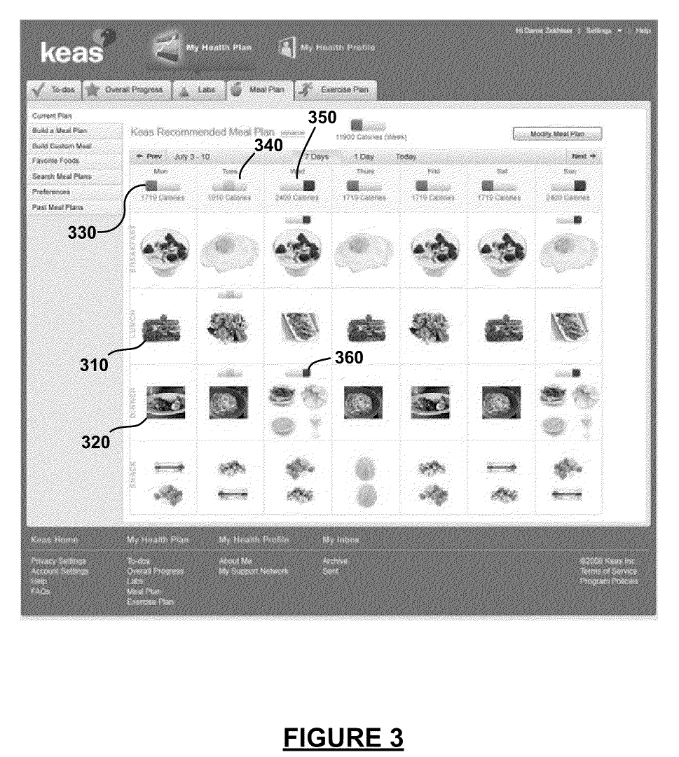

Protocol rules can be executed with respect to the user data according to the coaching protocol at step 230 and as shown in FIG. 3. The protocol rules are executed by coaching engine 124 according to the authored protocol. Protocol rules can be executed through execution of one or more coaches periodically, based on a previous action, or in response to some other event. Coaches can be executed for a user at least once a day.

Executing protocol rules includes retrieving a health service user list by coaching engine 124. The health service user list can be stored on application server 120 or data store 110 and includes a list of users participating in the health service. Coach engine 124 can then retrieve a coach list for each user in the user list. The coach list can be retrieved from application server 120 or data store 110 and includes a list of coaches (e.g., executable coach objects) to execute for each particular user. Each coach list can include an executable root coach for the user and may contain one or more additional executable coaches. The root coach is the initial coach in each coach list and in which each health service user is initially enrolled. As the user participates in the health coach service and the root coach is executed, the root coach may enroll the user in additional coaches. (e.g., the root coach software may add additional coach objects to the user's coach list)

The one or more coaches listed in a user coach list are selected by coaching engine 214 to be executed by a processor. The listed coaches can be executed in sequence in the order the coaches are listed in the user coach list. The coaches can be listed in the order they are added to the list, with the root coach at one end of the list and the most recently added coach at the other end of the list. Coaching engine 124 can first execute a root coach for a user, followed by execution of additional coaches in the order the coaches were added to the user coach list.

Each coach instance, or coach, can retrieve rules and actions. The rules can be retrieved by a coach instance from a rule library stored on application server 120 or from data store 110. Retrieving rules may include retrieving an expression having one or more attributes. The attributes can be retrieved from an attribute library stored on application server 120 or data store 110. Actions can be retrieved from an action library stored on application server 120 or data store 110. The retrieved rules are then executed by the coach instance.

A coach instance can evaluate one or more expressions having attributes and operations. The attributes can include simple and calculated attributes, such as height, weight, sex, BMI, LDL, blood pressure, and so forth. When a coach instance is created from a coach object, the coach instance retrieves the rule expression as well as user health data to provide values for expression attributes. The user health data values are used to carry out the coach instance expression as part of the protocol associated with the particular coach instance. The operation can indicate an expression to perform on the attribute, such as calculate a value for, determine if the attribute has a value of true or false, determine if the attribute value is greater than or less than some value or other attribute, or some other operator. Thus, an expression that includes an attribute and an operation performed on the attribute can be evaluated to determine if a particular condition regarding the attribute exists.

A trend function is a type of expression that evaluates the trend of an attribute value over time. A trend function can determine if a particular attribute value has increased over time, has surpassed a particular value a certain number of times over a time period, whether the attribute value experienced a particular rate of increase decrease over time, or some other trend. For example, a rule may perform an action of enlisting a user in a diet program if a user's body mass index has increased greater than a threshold rate over a period of time. Trend calculations can be evaluated using health data in several ways. A coach instance can determine a trend by comparing selected indicia of a series of data points such as a first value and a last value, comparing data points selected by identifying data points by time and date, or comparing the trend between a past date or current date and a delta of time.

When no specific data points correspond to a desired date and time for which a data value is needed for trend evaluation, the data points may be calculated using a set of guidelines. When there is only one data point for a particular attribute, the single value can be used for the desired date and time. If the trend of user's weight is desired over the last three months but the only available weight data point is for a date three months ago, the previous value of the user's weight can be used for both a previous value and current value thus resulting in a trend of zero change. If the date and time for a desired attribute data point is after the most recent value for the attribute, then the most recent attribute value is used for the required attribute data and time. If the date and time for a desired attribute data point is before the first known value for the attribute, then the first known attribute value is used for the required attribute data and time. If the attribute date and time is between two existing attribute value dates, then the two attribute values that surround the desired attribute date and time can be linearly interpolated to determine the attribute value at the required date and time.

Once a coach instance is created and the coach rule is evaluated, a determination is made as to whether the expression is evaluated to be true. A coach expression can be constructed as a condition, such as whether a particular attribute value is within a particular range, whether a user has performed an action, or some other condition. The operators to form the condition may be retrieved by the coach instance from an operator library stored on application server 120 or data store 110. Evaluating the expression condition can result in a value of true if the condition is met or false if the condition is not met.

If a rule expression for a coach is evaluated to be true, the coach instance containing the expression determines the last time the action corresponding to the expression was performed. Coaching engine 124 can maintain a user action log 112 for each user of the health coach service. The user action log 112 can be maintained on application server 120 or data store 110 and accessed by a coaching instance. When an action is performed for a user, the action can be logged in the user action log 112. To determine the last time an action corresponding to an expression was performed, coaching engine 124 may query the user action log for the most recent entry for the particular action.

For expressions evaluated to be true, the date the corresponding action was last performed is compared to a periodicity period for the expression by the coaching instance. The comparison is performed to determine if the action should be performed in response to the most recent expression evaluation. The periodicity period can indicate the maximum frequency at which the action can be performed. If the time period between the last performance of the action and the current time is less than the periodicity period, the action is not performed. If the time period since the last time the action was performed is greater than the periodicity period, the action corresponding to the evaluated expression can be performed by the coach instance.

Returning to the method of FIG. 2, after executing protocol rules for a coach instance, one or more actions are performed and the action results and user status are reported at step 240. The results and status can be reported as an alert, via e-mail, posting within a content page provided by the health coach service, or in some other manner.

The action for an expression evaluated to be true is performed or “fired” if the periodicity time period has expired since the last time the action was performed. The action can include enrolling the user in a coach or program, such as a diet program or workout program. A diet program may specify a maximum number of calories that a user should consumer per day, provide meal plan options, track a users dieting progress, and dynamically update based on user progress. A workout program may specify the number of calories that a user should “burn” or expend during exercise per day. A user can be enrolled in additional coaches to guide the user with respect to other health issues.

A rule action may also include providing a user notification, instructions to get a lab test performed or see a particular health care provider, fill out a questionnaire, improve a value, or some other action. A user notification may be provided when a user has failed to perform a particular action, when an attribute value has exceeded a threshold, or some other event has been detected. The notification can include notification information provided through a web page by the health coach service coaching engine 124 to client 160. Instructions to get a lab test completed or see a health care provider may include a notification to a user and a notification to a medical professional 175 at client 170. The notification may request user 155 and medical professional 175 to schedule an appointment for a user lab test or other medical appointment. A rule action can be tagged with content such as a blog, pod cast, video, audio, image, or some other data. When the rule is executed, the content can be forwarded to the user as part of the performed action if the conditions for the rule have been met. For a questionnaire, the coach instance may invoke a questionnaire engine to provide the questionnaire to the user. The questionnaire engine may retrieve questions from a questionnaire library, construct the questionnaire, and provide the questionnaire to the user, such as through a coach service web page.

A coach instance can, for example, be used to create a meal plan based on user goals and a user's current medical condition as part of an action performed for the user. The health level of the plan may be determined based on how well the meal contributes to the goals of the user as well as the value to the user based on the user's current condition. If a user has high blood pressure, meals with a high cholesterol level may be determined to be undesirable (red level) while those with lower cholesterol levels may be desirable (green level). Similarly, if a user is trying to lose weight, meals with a high level of calories may be undesirable (red level) while meals with a low level of calories may be desirable (green level). In addition to providing the health associated with an entire day or week, health information can also be provided based on ingredients consumed for a meal or day.

FIG. 3 is an exemplary interface that provides a meal plan for a user. The meal plan may be determined for the user and provided to the user through the interface as part of an action performed for the user by a coach instance. The interface of FIG. 3 illustrates meal plan information for the current seven day week. Aspects of the meal plan may be provided for a single day, a future set of days, a future week, or some other time period.

For each day in the meal plan, the interface illustrates icons associated with the scheduled meals, which may include breakfast, lunch, dinner, and snacks. The icons are images representing a portion of each meal, such as sandwich image 310 representing a lunch meal and a chicken dish image 320 representing a dinner meal. The interface also provides an indicator as to a general rating for the level of health for each day's meal. The icon 330 for the Monday meal plan is a green colored indicator associated with a healthy level, the icon 340 for Tuesday's meal plan is a yellow colored indicator associated with a somewhat healthy level, and the icon 350 for Wednesday's meal plan is a red colored indicator associated with an unhealthy level. For daily meal plans that are not considered healthy, an indicator is associated with the particular meal for that day that detracts from the healthy rating. For the Wednesday meal plan, a red colored icon 360 is illustrated for the breakfast meal and the dinner meal, indicating that these meals are unhealthy and contribute to the overall unhealthy level of the meal plan for Wednesday. The overall health level of the meal plan for the week may also be indicated, such as by a green indicator representing the health level of the current week as “healthy” and positioned near the top of the meal plan in FIG. 3.

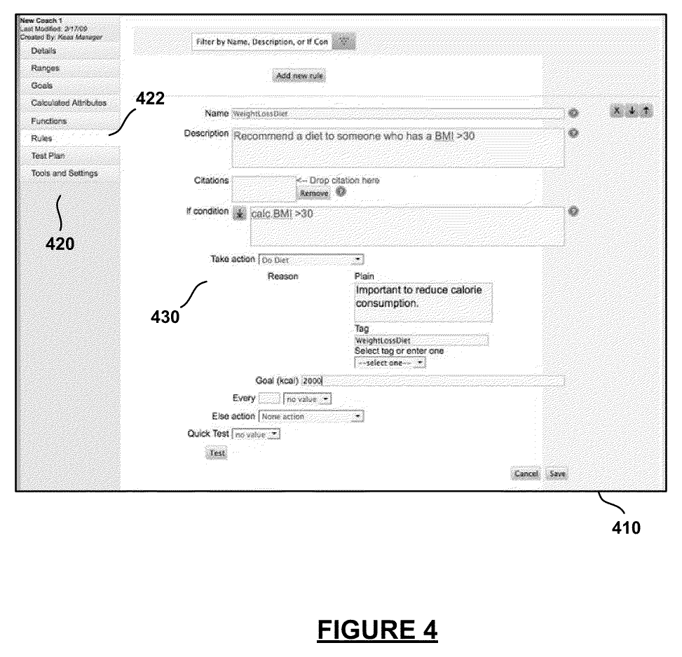

FIG. 4 is an exemplary interface 410 for recommending a dieting coach for a user. The dieting coach can be recommended as a rule action to perform when a condition for the rule is met. The interface 410 includes a tab window 420 and configuration window 430. Tab window 420 includes tabs associated with portions of a coach that can be configured by an author 155 and processed by coaching engine 124. In the interface 410, the rules tab 422 is selected by an author through an input device of client 150. Configuration window 430 includes a series of input boxes that allow an author 155 to configure a rule which can be executed by coaching engine 124. The input boxes allow an author to provide a rule name, description, citation, if condition or expression, action, tag, goal, periodicity and other data. The rule name is, in FIG. 4, provided as “WeightLossDiet,” the rule description is entered as “Recommend a diet to someone who has a BMI>30,” and the rule if condition or expression is entered as “cacl.BMI>30.” In the expression, the “BMI” term identifies a calculated attribute, the “calc” term indicates that values of the appropriate attribute should be calculated, the “>30” term indicates that an action is taken if the calculated attribute value is over 30. The citations and periodicity input boxes are blank in interface 410.

The selected rule action is performed if the rule expression is evaluated to be true. The rule may include an action and, in some instances, content to provide with an action. The content may be identified by a “tag” associated with the content. The rule action, in FIG. 4, is provided as “Do Diet”, the rule tag is provided as “WeightLossDiet,” and the Goal in kilo-calories is “2000.” When the coach is executed for a user 165, the coach executes the rule to determine if the user's BMI is over 30. If the user BMI value is over 30, another coach titled “Do Diet” is executed for the user 165, an article titled “WeightLossDiet” is provided to the user 165, and the user calorie intake goal becomes 2000.

Each rule may be configured with additional data such as quick test data for testing evaluation of the expression and whether a confirmation should be received from a user that a notification or other action has been performed. The quick test data configuration can identify a file of data which provides values for the expression. An author 150 can have the expression evaluated by selecting the “test” button after a test file of data is identified. The coaching engine 124 will evaluate the expression using the quick test data and provide the results to an author 150 in a separate interface 410. A confirmation requirement tracks whether a user has provided confirmation as to whether a notification was read, a health provider appointment was made, or some other action was completed.

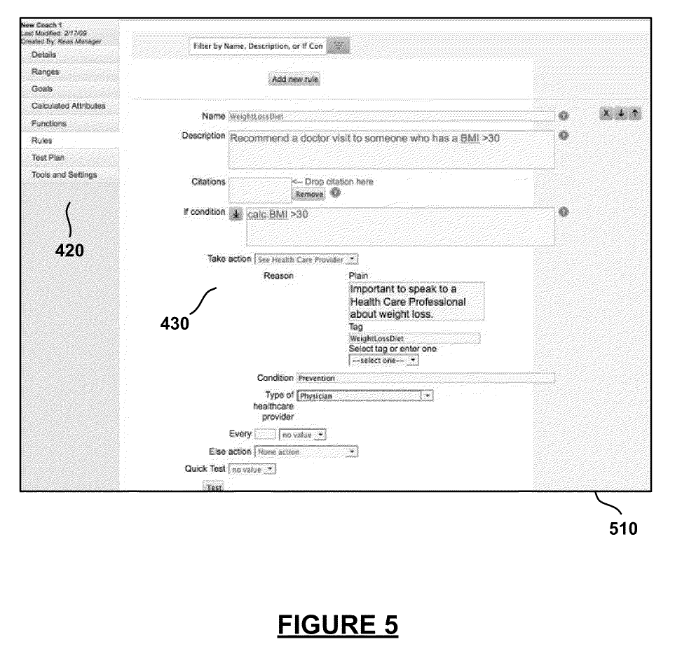

FIG. 5 is an exemplary interface 510 for recommending a health provider (e.g., medical professional 175) appointment. The health provider can be recommended by performing a rule action when a condition for the rule is met. The interface 510 includes a tab window 520 and configuration window 530. Configuration window 530 includes a series of input boxes that allow an author 155 to configure a rule which can be executed by coaching engine 124. The input boxes allow an author 155 to provide a rule name, description, citation, if condition, action, tag, secondary condition, provider type, periodicity and other data. The rule name, in FIG. 5, is provided as “WeightLossDiet,” the rule description is entered as “Recommend a doctor visit to someone who has a BMI>30,” and the rule if condition or expression is entered as “cacl.BMI>30.” The ‘if’ condition in interface 510 is calculated in the same manner as that in interface 410. The periodicity input box is blank in interface 510. The selected rule action is performed if the rule expression is evaluated to be true. The rule action is provided as “See Health Care Provider”, the rule tag is provided as “WeightLossDiet,” the secondary condition is “Prevention,” and the type of health care provider is “Physician.” When the coach is executed for a user 165, the coach performs an action of executing a See Health Care Provider coach if the user's BMI is over 30. Additionally, an article titled “WeightLossDiet” is provided to the user 165.

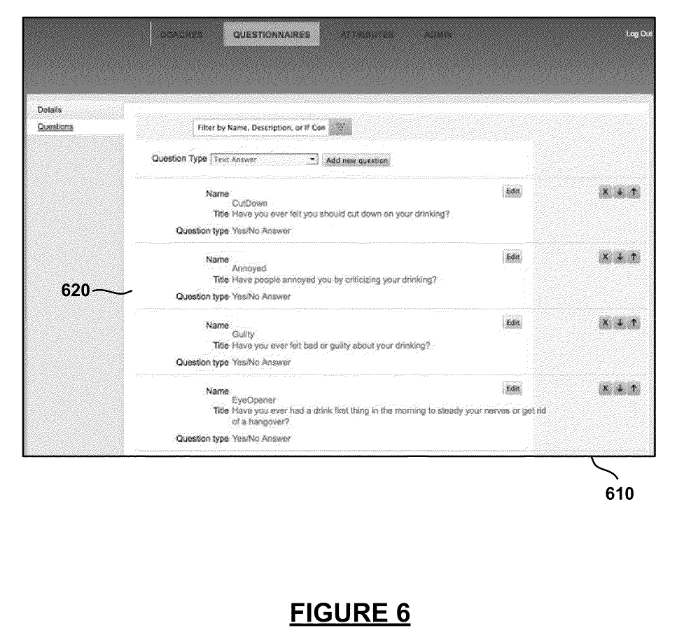

FIG. 6 is an exemplary interface 610 for providing a questionnaire for a user. Interface 610 includes a question configuration window 620 for allowing an author 155 to configure one or more questions to provide as part of a questionnaire. The questionnaire can be provided to a user 165 as an action performed in response to determining a rule if condition to be have a value of “true.” Each question can be configured with a name, title, and question type.

The first question, in FIG. 6, has a name of “CutDown,” a title of “Have you ever felt you should cut down on your drinking?,” and a question type of “Yes/No Answer.” For each question, the questionnaire may include the question title and allow a user 165 to provide an answer that complies with the question type. With respect to the first configured question in interface 620, a user 165 may indicate whether they have ever felt they should cut down on their drinking by selecting an answer of “yes” or “no.” Questions can also be in a multiple choice, text answer, or some other format. Once the questionnaire is completed, it can be saved by coaching engine 124 and selected to be sent to a user as an action performed by an executing coach when evaluation of a rule if condition returns as “true.”

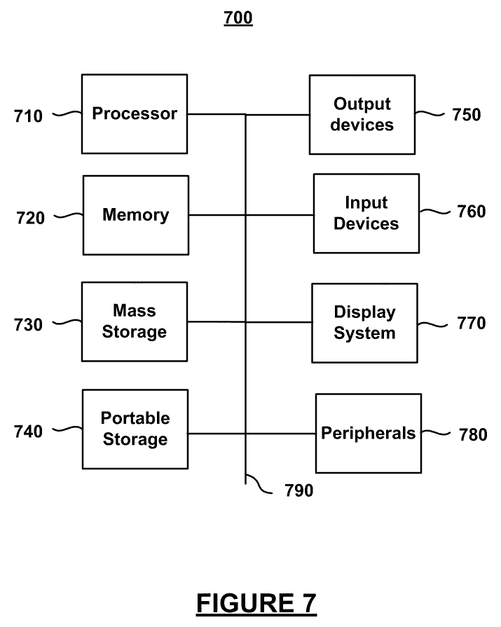

FIG. 7 illustrates an exemplary computing system 700 that may be used to implement an embodiment of the present invention. System 700 of FIG. 7 may be implemented in the contexts of the likes of data store 110, application server 120, network server 130, database 122, and clients 150-160. The computing system 700 of FIG. 7 includes one or more processors 710 and memory 710. Main memory 710 stores, in part, instructions and data for execution by processor 710. Main memory 710 can store the executable code when in operation. The system 700 of FIG. 7 further includes a mass storage device 730, portable storage medium drive(s) 740, output devices 750, user input devices 760, a graphics display 770, and peripheral devices 780.

The components shown in FIG. 7 are depicted as being connected via a single bus 790. The components may be connected through one or more data transport means. Processor unit 710 and main memory 710 may be connected via a local microprocessor bus, and the mass storage device 730, peripheral device(s) 780, portable storage device 740, and display system 770 may be connected via one or more input/output (I/O) buses.

Mass storage device 730, which may be implemented with a magnetic disk drive or an optical disk drive, is a non-volatile storage device for storing data and instructions for use by processor unit 710. Mass storage device 730 can store the system software for implementing embodiments of the present invention for purposes of loading that software into main memory 710.

Portable storage device 740 operates in conjunction with a portable non-volatile storage medium, such as a floppy disk, compact disk or Digital video disc, to input and output data and code to and from the computer system 700 of FIG. 7. The system software for implementing embodiments of the present invention may be stored on such a portable medium and input to the computer system 700 via the portable storage device 740.

Input devices 760 provide a portion of a user interface. Input devices 760 may include an alpha-numeric keypad, such as a keyboard, for inputting alpha-numeric and other information, or a pointing device, such as a mouse, a trackball, stylus, or cursor direction keys. Additionally, the system 700 as shown in FIG. 7 includes output devices 750. Suitable output devices include speakers, printers, network interfaces, and monitors.

Display system 770 may include a liquid crystal display (LCD) or other suitable display device. Display system 770 receives textual and graphical information, and processes the information for output to the display device.

Peripherals 780 may include any type of computer support device to add additional functionality to the computer system. Peripheral device(s) 780 may include a modem or a router.

The components contained in the computer system 700 of FIG. 7 are those typically found in computer systems that may be suitable for use with embodiments of the present invention and are intended to represent a broad category of such computer components that are well known in the art. Thus, the computer system 700 of FIG. 7 can be a personal computer, hand held computing device, telephone, mobile computing device, workstation, server, minicomputer, mainframe computer, or any other computing device. The computer can also include different bus configurations, networked platforms, multi-processor platforms, etc. Various operating systems can be used including Unix, Linux, Windows, Macintosh OS, Palm OS, and other suitable operating systems.

The foregoing detailed description of the technology herein has been presented for purposes of illustration and description. It is not intended to be exhaustive or to limit the technology to the precise form disclosed. Many modifications and variations are possible in light of the above teaching. The described embodiments were chosen in order to best explain the principles of the technology and its practical application to thereby enable others skilled in the art to best utilize the technology in various embodiments and with various modifications as are suited to the particular use contemplated. It is intended that the scope of the technology be defined by the claims appended hereto.

What is claimed is:

1. A method for executing a health coach for a user, comprising:
creating a health coach by an application for a user associated with a first set of stored user health data, the health coach stored in memory and executable by a processor, the application stored and executed at a computing device;
performing a first action by the health coach at the computing device based on the user health data;
storing updated user health data in memory by the application based on the performed first action;
executing the health coach based on the updated user health data; and
performing a second action by the health coach at the computing device based on the updated user health data.

2. The method of claim 1, further comprising:
instantiating a health coach object with user health data to create a health coach instance based on the user health data; and
executing the health coach instance.

3. The method of claim 1, further including:
retrieving a rule containing an expression by the health coach; and
executing the rule expression by the health coach based on user health data.

4. The method of claim 1, wherein the first action results in receiving user information by the application used to update user health data by the application.

5. The method of claim 1, further comprising:
evaluating an expression by the health coach; and
performing the first action based on the result of the expression.

6. The method of claim 1, further comprising determining that a time for a most recent performance of the first action satisfies a minimum period threshold.

7. The method of claim 1, further comprising:
calculating a trend in a portion of the user health data; and
performing the user action based on the calculated trend.

8. The method of claim 1, further comprising:
retrieving a list of users of a coach service by an application on a server; and
retrieving a list of health coaches for a user in the user list by the application, the list of health coaches including the executed health coach.

9. The method of claim 1, wherein the first action or the second action includes enrolling the user in diet plan by the application.

10. The method of claim 1, wherein the first action or the second action includes enrolling the user in workout plan by the application.

11. The method of claim 1, wherein the first action or the second action includes providing a questionnaire interface to the user by the application.

12. The method of claim 1, wherein the first action or the second action includes providing a notification to a health care provider by the application.

13. A method for executing a coach protocol for a user, comprising:
retrieving a list of users of a coach service from memory by an application stored and executed on a computing device;
retrieving a list of health coaches for a user in the user list from memory by the application;
executing the health coaches listed in the health coach list by the application; and
performing an action at the computing device based on user health data by at least one of the executed coaches on the computing device

14. The method of claim 13, wherein the list of health coaches includes a root coach and at least one additional coach.

15. The method of claim 13, further comprising instantiating a health coach object.

16. The method of claim 13, further comprising passing user health data to the health coach object to create a health coach instance.

17. The method of claim 13, further comprising executing an expression contained in the health coach.

18. The method of claim 13, further comprising:
retrieving a rule by a health coach instance;
retrieving user health data by the health coach instance; and
evaluating a rule expression using user health data.

19. The method of claim 13, further comprising identifying whether a health coach expression evaluation results in performing an action.

20. The method of claim 13, further comprising performing an action based on the occurrence of an identified data trend.

21. The method of claim 13, further comprising identifying that an action can be performed based on a periodicity threshold.

22. The method of claim 21, further comprising comparing the last time an action was performed to a frequency periodicity threshold for performing the action.

23. The method of claim 13, wherein performing the action includes enrolling the user in an additional health coach.

24. A computer readable storage medium having embodied thereon a program, the program being executable by a processor to perform a method for authoring a protocol to coach a user, the method comprising:
creating a health coach by an application for a user associated with a first set of stored user health data,, the health coach stored in memory and executable by a processor, the application stored and executed at a computing device;
performing a first action by the health coach at the computing device based on the user health data;
storing updated user health data in memory by the application based on the performed first action;
executing the health coach based on the updated user health data; and
performing a second action by the health coach at the computing device based on the updated user health data.

25. The computer readable storage medium of claim 24, the method further comprising:
instantiating a health coach object with user health data to create a health coach instance based on the user health data; and
executing the health coach instance.

26. The computer readable storage medium of claim 24, the method further including:
retrieving a rule containing an expression by the health coach; and
executing the rule expression by the health coach based on user health data.

27. The method of claim 24, wherein the first action results in receiving user information by the application used to update user health data by the application.

28. The computer readable storage medium of claim 24, the method further comprising:
evaluating an expression by the health coach; and
performing the first action based on the result of the expression.

29. The computer readable storage medium of claim 24, the method further comprising determining that a time for a most recent performance of the first action satisfies a minimum period threshold.

30. The computer readable storage medium of claim 24, the method further comprising:
calculating a trend in a portion of the user health data; and
performing the user action based on the calculated trend.

31. The computer readable storage medium of claim 24, the method further comprising:
retrieving a list of users of a coach service by an application on a server; and
retrieving a list of health coaches for a user in the user list by the application, the list of health coaches including the executed health coach.

32. The computer readable storage medium of claim 24, wherein the first action or the second action includes enrolling the user in diet plan or a workout plan by the application.

33. The computer readable storage medium of claim 24, wherein the first action or the second action includes providing a questionnaire interface to the user by the application.

34. The computer readable storage medium of claim 24, wherein the first action or the second action includes providing a notification to a health care provider by the application.
